(19) United States
(12) Patent Application Publication
(10) Pub. No.: US 2026/0334451 A1
(43) Pub. Date: Oct. 29, 2026

(54) INSECT TRAP HOLDERS

(71) Applicant: HUB Enterprises, LLC, Scotts Mills, OR (US)

(72) Inventor: Hubert Hettwer, Scotts Mills, OR (US)

(73) Assignee: HUB Enterprises, LLC, Scotts Mills, OR (US)

(21) Appl. No.: 19/655,410

(22) Filed: Apr. 22, 2026

Related U.S. Application Data
(60) Provisional application No. 63/793,079, filed on Apr. 23, 2025.

(51) Int. Cl. A01M 1/16

(52) U.S. Cl. CPC A01M 1/165; A01M 2200/012

(57) ABSTRACT

Insect trap holders are shown and disclosed. In some examples, the insect trap holders include a rear base having a front surface and a back surface, and at least one fastener attached to, or formed with, the front surface of the rear base, the at least one fastener configured to secure a trap base of at least one insect ribbon trap. The insect trap holders additionally include at least one hook spaced from the at least one fastener and attached to, or formed with, the front surface of the rear base, the at least one hook configured to secure an end of the at least one insect ribbon trap, and a front cover detachably attached to the rear base to define a working volume therebetween containing the at least one insect ribbon trap. The front cover includes a plurality of apertures sized to allow insects into the working volume.

### CROSS REFERENCE TO RELATED APPLICATIONS

This application claims the benefit of U.S. Patent Provisional Application No. 63/793,079 filed on Apr. 23, 2025 and entitled “Insect Trap Cover”. The completed disclosure of the above application is hereby incorporated by reference for all purposes.

### FIELD OF THE DISCLOSURE

The present disclosure pertains to holders for holding one or more insect traps, such as insect ribbon traps and insect glue traps.

### BACKGROUND

Insects are a constant nuisance to homes and businesses. Countless strategies have been devised to mitigate the presence of such pests. One popular method of trapping insects is through the use of disposable ribbons or sheets coated with adhesive. However, such adhesive traps provide a very unpleasant display of the trapped insects. Other methods include powered traps that integrate lights and/or ultrasonic attractants. However, those methods require power and constrain the user to positioning the trap near an electrical outlet and require the user to constantly charge the powered traps.

What is needed, therefore, is an insect trap holder that hides the trapped insects from view and also does not require any power.

### BRIEF DESCRIPTION OF THE DRAWINGS

For a better understanding of the invention, and to show how the same may be carried into effect, reference will now be made, by way of example, to the accompanying drawings, in which:

FIG. 1 is an isometric view of an illustrative example of an insect trap holder;

FIG. 2 is an exploded view of the insect trap holder of FIG. 1; and

FIG. 3 is a partial side view of the insect trap holder of FIG. 1.

### DETAILED DESCRIPTION

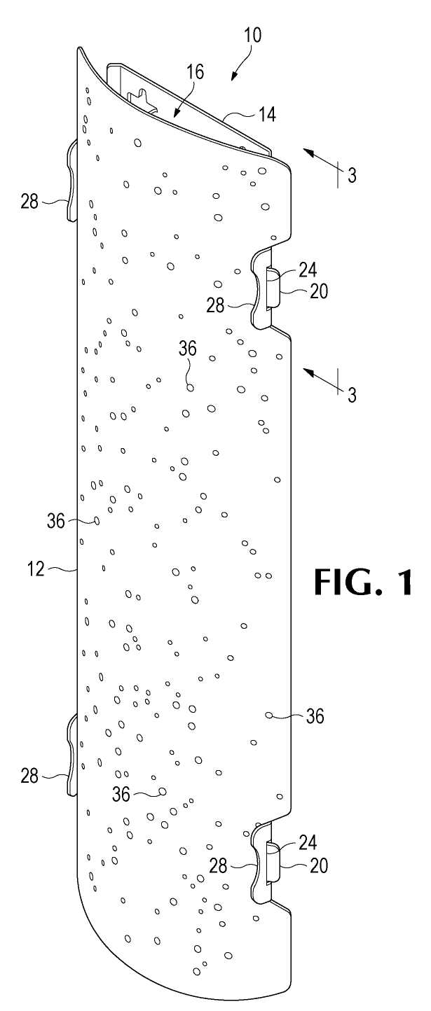

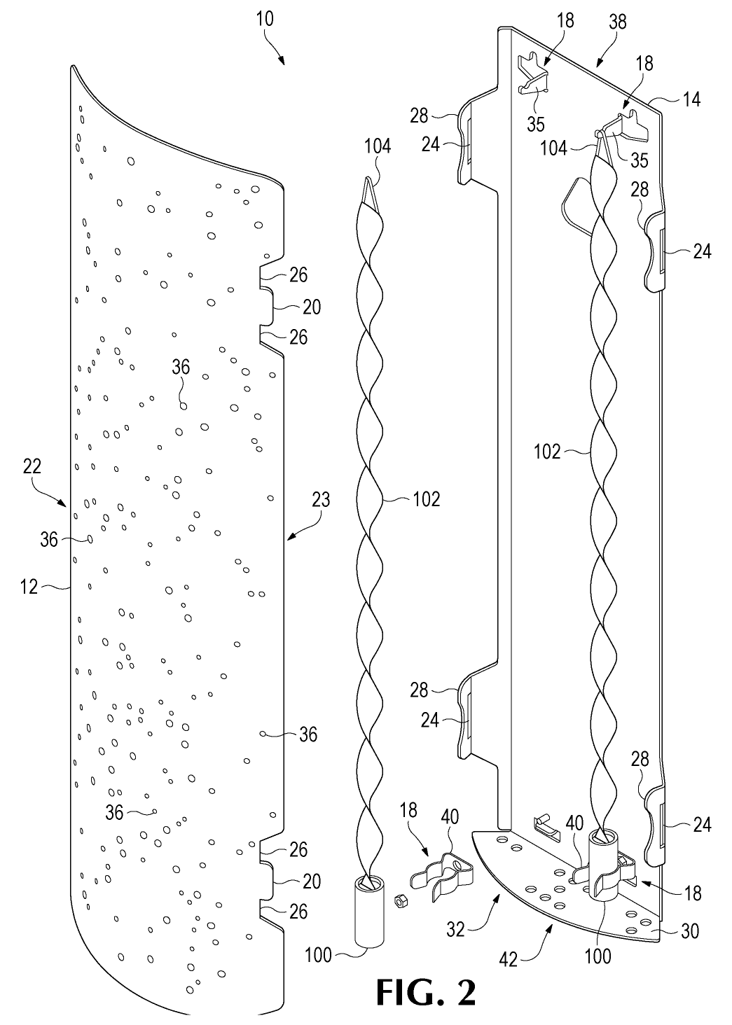

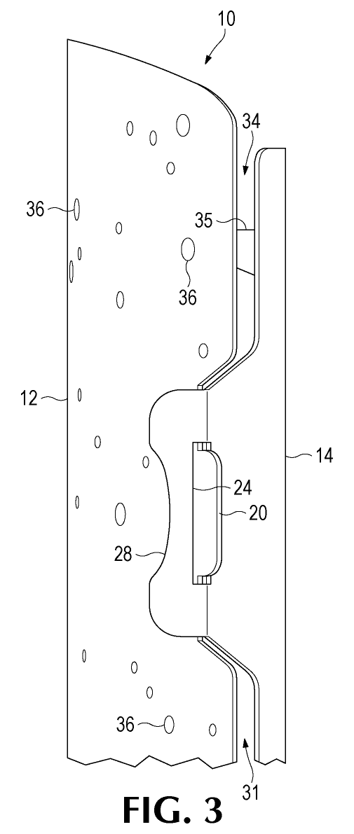

Referring to FIGS. 1-3, an insect trap holder or insect trap cover 10 is shown. The insect trap holder receives one or more insect traps, such as insect strips (e.g., fly strips), insect ribbon traps, and insect sheets, and provides concealment of the insect traps and the trapped insects while maintaining the effectiveness of the received insect traps.

In the example shown in FIGS. 1-3, the insect trap holder includes a front cover 12 and a rear base or rear cover 14 that attach to each other to form a working volume 16 therebetween, and one or more insect trap assemblies 18. The front and rear covers may be any suitable shape(s). In the example shown in FIGS. 1-3, the front cover is arcuate and the rear cover is flat or planar to provide a larger working volume 16 and more access points for the insects as further discussed below. However, other examples may include a front cover 12 or a rear cover 14 having a flat, planar base and planar sides that are perpendicularly or obtusely attached to, or formed with, the planar base.

Front cover 12 includes spaced tabs 20 along its opposed transverse ends 22 and 23 that are received in corresponding slots 24 of rear cover 14. The tabs may be formed on the front cover via notches 26. The front cover also may include a latching mechanism (not shown) to secure and/or interlock the tabs in the slots. The slots of rear cover 14 are positioned on outward extending arms 28 attached to, or formed with, transverse ends 30 of the rear cover to define side gaps 31 between the front and rear covers to provide for insect access between those covers. Although the front cover is shown to include the tabs and the rear cover is shown to include the corresponding slots, the rear cover may alternatively include the tabs and the front cover may alternatively include the corresponding slots (with or without the outwardly extending arms). Alternatively, or additionally, the front and/or rear covers may include hinges and/or other fasteners (not shown).

Rear cover 14 also includes an elongate base or back panel 28 and a bottom panel 30 perpendicularly attached to, or formed with, the back panel. The bottom panel extends toward the front cover (but does not contact the front cover to provide another gap or access point 32 for insects) and provides a surface to collect and/or contain insects, such as insects that fall off the insect traps. In the example shown in FIGS. 1-3, the rear cover does not include a top panel providing another gap or access point 34 for the insects. Although rear cover 14 is shown to include back panel 28 and bottom panel 30, other examples of rear cover 14 may exclude the bottom panel and/or include a top panel.

The front and/or rear covers include a plurality of holes 36, which may be randomly distributed and/or evenly distributed across length of the cover(s). Additionally, the holes may be the same and/or different sizes to allow insect access through the holes (in addition to, or instead of, through one or more of the gaps or access points discussed above) but not too large to allow people to see the insects trapped in the working volume of the insect trap holder. Examples of suitable hole sizes include 1/8", 1/4", 5/16", and/or any suitable combination of two or more of the above sizes and/or other similar sizes. In some examples, the bottom panel may have fewer and/or smaller holes (or no holes) to better contain the insects.

Insect trap assemblies 18 receive one or more insect traps, such as insect ribbon traps, within working volume 16. In the example shown in FIGS. 1-3, the insect trap assemblies include one or more hooks 36 adjacent a longitudinal end 38 of a front surface or an internal surface (i.e., surface facing the front cover) 38 of the back panel of the rear cover and one or more fasteners 40 (e.g., spring clips) adjacent to an opposed longitudinal end 42 of the back panel of the rear cover. The hook(s) and/or clip(s) may be incorporated with or attached to the rear cover. When attached to the rear cover, screws, lock nuts, and/or other fasteners may be used to secure the hook(s) and/or clip(s) to the rear cover. The fasteners of the insect trap assemblies receive a trap base 100 of insect traps 102 and the hooks receive a hanging or working end 104 of those traps. Other types of connectors may alternatively, or additionally, be included to receive the insect traps within the working volume.

The insect trap holders of the present disclosure may be mounted to a wall, placed on a ground surface (either vertically or horizontally), or hung from above. For example, the insect trap holders may include one or more feet or stands (not shown) that are attached to (e.g., bolted) to one or both of the front and rear covers. The stand may include a stand base and a stand panel attached to, or formed with, the base. The stand may be used to align the insect trap holder vertically or horizontally. In some examples, the stand may be adjustable to allow the stand to be moved between a deployed or extended position and a folded or storage position. Alternatively, the insect trap holders may include a hanger that is attached to, or formed with, the front and/or rear covers. The hanger may be used to suspend the insect trap holder above the ground.

The insect trap holders of the present disclosure provide a passive (non-powered) solution that requires no power and no batteries and thus the insect trap holders do not require an electrical outlet. Additionally, the insect trap holders of the present disclosure are compatible with existing consumable insect traps. Specifically, the holders are designed to integrate with many styles of adhesive traps that currently exist in the mark. The holders provide a plurality of hooks/fingers that allows for hanging and tensioning of existing adhesive traps.

Moreover, the insect trap holders of the present disclosure provide passive concealment while maintaining attractant effectiveness. Existing adhesive traps use embedded chemical and visual attractants to lure pests into the adhesive. Completely obscuring the adhesive trap from view would interfere with passive visual attractants so that humans would not see the traps but neither would the insects. The insect trap holders of the present disclosure are designed with strategically placed openings in the exterior surface to allow pests to detect those attractants, while obscuring the unsightly organic accumulation from human passersby. Specifically, there are openings for insects to access the trap(s) on the top, bottom, both sides, front, and every exposed face. Using the camouflage principle of disruption, the hole/perforation pattern partially obscures the trap(s) and creates shadows that disrupt the continuous visual shape of the adhesive trap(s), disguising the enclosed trap(s) and making it difficult to clearly see the insects stuck to the adhesive trap(s).

To substantiate the scope of this disclosure, an extensive array of alternative embodiments can be considered, accommodating various materials, sizes, attachment mechanisms, and methods of attachment. This adaptability ensures the invention can be tailored to meet diverse requirements and applications. For example, the insect trap holders may include specialized features for various purposes that can be offered as optional accessories. The insect trap holders may, for example, include or be configured as decorative sculpture, trellis for indoor climbing plants, signage, brightly colored safety barriers (e.g., safety cones or bollards), doorstop, or support legs for table.

In some embodiments, however, the insect trap holders of the present disclosure include only the components described above and/or shown in FIGS. 1-3 to the exclusion of other components and/or structures not described and/or shown. For example, the front cover may include only a front base having spaced tabs on transverse ends and a plurality of holes to allow insects to enter the working volume. Additionally, the rear cover may include only the back panel, the bottom panel, the outwardly extending arms with the slots on the transverse ends of the back panel, the one or more hooks attached to, or formed with, the back panel, and the one or more trap fasteners attached to, or formed with, the back panel.

The various components of the disclosure can be fabricated from an assortment of materials, including different plastics, metals, alloys, and/or composite materials. The choice of material depends on the desired strength, weight, and environmental considerations, allowing for versatile design options.

In addition to the foregoing description, it is to be understood that various embodiments and modifications of the invention may be readily apparent to those skilled in the art without departing from the spirit or scope of the present invention. It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. An insect trap holder, comprising:
a rear base having a front surface and a back surface;
at least one fastener attached to, or formed with, the front surface of the rear base, the at least one fastener configured to secure a trap base of at least one insect ribbon trap;
at least one hook spaced from the at least one fastener and attached to, or formed with, the front surface of the rear base, the at least one hook configured to secure an end of the at least one insect ribbon trap; and
a front cover detachably attached to the rear base to define a working volume therebetween containing the at least one insect ribbon trap, the front cover having a plurality of apertures sized to allow insects into the working volume, and at least one of the front cover or rear base being shaped to provide one or more gaps between the front cover and the rear base to allow insects into the working volume other than through the plurality of apertures when the front cover is attached to the rear base.

2. The insect trap holder of claim 1, wherein the rear base includes opposed transverse ends each having at least one slot.

3. The insect trap holder of claim 2, wherein the front cover includes opposed transverse ends each having at least one tab that is sized to be received in a corresponding slot of the at least one slot of the rear base.

4. The insect trap holder of claim 1, wherein the rear base includes a back panel and a bottom panel that is perpendicularly attached to, or formed with, the back panel.

5. The insect trap holder of claim 4, wherein the back panel and the bottom panel are each planar.

6. The insect trap holder of claim 5, wherein the front cover is arcuate.

7. The insect trap holder of claim 1, wherein the at least one fastener is a spring clip that is attached to the rear base.

8. An insect trap holder, comprising:
a rear base having a front surface and a back surface, the rear base including opposed transverse ends each having at least one slot, and the rear base including a planar back panel and a planar bottom panel that is perpendicularly attached to, or formed with, the back panel;
at least one spring clip attached to, or formed with, the front surface of the rear base, the at least one fastener configured to secure a trap base of at least one insect ribbon trap;
at least one hook spaced from the at least one fastener and attached to, or formed with, the front surface of the rear base, the at least one hook configured to secure an end of the at least one insect ribbon trap; and
an arcuate front cover detachably attached to the rear base to define a working volume therebetween containing the at least one insect ribbon trap, the front cover including opposed transverse ends each having at least one tab that is sized to be received in a corresponding slot of the at least one slot of the rear base, the front cover having a plurality of apertures sized to allow insects into the working volume, the arcuate front cover and the planar back panel defining one or more gaps between the front cover and the rear base to allow insects into the working volume when the front cover is attached to the rear base.
